(19) United States
(12) Patent Application Publication
(10) Pub. No.: US 2004/0038131 A1
(43) Pub. Date: Feb. 26, 2004

(54) Electrochemical element with ceramic particles in the electrolyte layer

(76) Inventors: Johannis Josephus Den Boer, Rijswijk (NL); Erik Maria Kelder, Delft (NL); John Foreman Stewart, Rijswijk (NL)

Correspondence Address: Richard F Lemuth, Shell Oil Company Intellectual Property, P O Box 2463, Houston, TX, 77252-2463, US

(21) Appl. No.: 10/257,553

(22) PCT Filed: Apr. 12, 2001
(86) PCT No.: PCT/EP01/04295

(30) Foreign Application Priority Data
Apr. 13, 2000 (EP) 00303112.7
Apr. 13, 2000 (EP) 00303113.5

(51) Int. Cl. H01M 10/36; H01M 4/58; H01M 10/04; H01M 4/50

(52) U.S. Cl. 429/304; 429/231.9; 429/321; 29/623.1; 429/224

(57) ABSTRACT

A solid-stated rechargeable battery or other electrochemical element for use at high (>40° C.) temperature comprises a cathodic and/or anodic electrode comprising, as a host material for alkali metal ions, a normal or inverse spinel type material and an electrolyte layer sandwiched between said electrodes, which layer comprises ceramic electrolyte particles that are essentially free of electronically conductive components, and which comprise less that 1% by weight of dissolved alkali containing salt thereby maintaining good performance as regards the capacities delivered during various charge/discharge cycles at a high temperature.

The present invention relates to an electrochemical element which comprises a cathodic and/or anodic electrode comprising a host material of a spinel type structure for hosting alkali metal ions, in particular lithium ions, and to the use of such an electrochemical element as a high-temperature rechargeable battery.

Insertions compounds have widely been used in electrochemical elements as a host material of an electrode. Examples of such insertion compounds are spinels of an alkali metal, a transition metal and oxygen or sulphur. For example, conventional lithium batteries are based, as an electrode material, on a spinel of which the alkali metal is lithium. During the charge of the electrochemical element alkali metal ions are extracted from the host material of the cathode into the electrolyte and alkali metal ions are inserted from the electrolyte into a host material of the anode. The reverse processes take place during discharging the electrochemical element. Ideally, the extraction from and insertion into the host materials proceeds reversibly and without rearrangement of the atoms of the host material. Thermal instability of the spinel type materials usually leads to a deviation of the ideal behaviour and, as a consequence, to a fading of the capacity during each charge/discharge cycle.

The content of alkali metal of the spinel varies during the charge/discharge cycle, and it frequently deviates from the formal stoichiometry of the original spinel, i.e. the spinel which was used in the manufacture of the electrochemical element. In this patent document, unless indicated otherwise, the term “spinel type material” embraces a spinel and a material which can be formed from a spinel by electrochemical extraction of alkali metal ion such as during a charge/discharge cycle.

The conventional electrochemical elements comprise frequently a polymeric binder in which particulate materials such as the host materials and conductivity enhancing fillers are imbedded, or they comprise a liquid comprising an alkali metal salt.

European patents Nos. 0885845 and 0973217 disclose electrochemical elements having an electrode comprising a host material of a spinel type structure, which elements are not designed for use at high temperature.

European patent No. 0656667 discloses an electrochemical element which is designed for use at a temperature up to 30° C. U.S. Pat. No. 5,160,712 discloses an electrochemical element having a layered electrode structure which is not of the spinel type.

U.S. Pat. Nos. 5,486,346 and 5,948,565 disclose synthesis methods for active components of electrochemical elements wherein during a drying step the temperature of the melt may be raised to 70-100° C.

Many industrial operations take place at a temperature substantially above room temperature. Such high temperature operations take place, for example, inside the processing equipment used in the chemical industry, and in down hole locations in the exploration and production of gas and oil. In such operations measuring and control devices may be used which need a source of electrical energy. Conventional spinel based electrochemical elements are not preferred for use in this application because of insufficient thermal stability of spinel type materials at the prevailing temperature. It would be desirable to use in such operations electrochemical elements which can be subjected to charge/discharge cycles without or with less capacity fading.

The spinels which are conventionally used in electrochemical elements have a crystal structure in which the oxygen atoms are placed in a face centred cubic arrangement within which the transition metal atoms occupy the 16d octahedral sites and the alkali metal atoms occupy the 8a tetrahedral sites and are frequently indicated by the term “normal spinel”. In this patent document the commonly known, standard Wyckoff nomenclature/notation is used in respect of the crystal structure of spinel type materials. Reference may be made to “The International Tables for X-ray Crystallography”, Vol. I, The Kynoch Press, 1969, and to the JCPDC data files given therein.

Spinels in which alkali metal atoms occupy 16d octahedral sites, instead of 8a tetrahedral sites, and transition metal atoms occupy 8a tetrahedral sites, instead of 16d octahedral sites, are frequently indicated by the term “inverse spinel”. Inverse spinels can be distinguished from the normal spinels by their X-ray diffraction patterns and/or their neutron diffraction patterns.

U.S. Pat. No. 5,518,842, U.S. Pat. No. 5,698,338 and G T K Fey et al. (Journal of Power Sources, 68 (1997), pp. 159-165) disclose the use of an inverse spinel as the cathode material of a lithium battery. G T K Fey et al. concluded that the inverse spinel structures do not seem capable of delivering capacities comparable with those of the best cathodes for lithium batteries.

It is an object of the present invention to provide an electrochemical element that can be subjected to a plurality of charge/discharge cycles at a high temperature, with a good performance as regards the capacities delivered and maintained during the various charge/discharge cycles.

The solid-state electrochemical element according to the invention thereto comprises a layer of electrolyte which is sandwiched between cathode and anode electrodes. Said electrodes comprise an alkali metal ion and host material of a spinel type structure containing active component and an electronically conductive component, which components are at least partly covered by a liquid film coating and are embedded in a matrix binder material. The electrolyte layer comprises ceramic electrolyte particles that are essentially free of electrically conductive components and comprise less than 1% by weight of dissolved alkali-containing salt, such as LiPF₆, LiBF₄, LiClO₄ or triflates. Said particles are at least partly covered by a liquid film coating and are embedded in a matrix binder material.

Preferably, the ceramic electrolyte particles comprise less than 0.5% by weight of dissolved alkali containing salt, are substantially free of C, Al, Cu or other electronically conductive components and are at least partly covered by a film of a polar liquid.

The gist of certain embodiments of the present invention is that specific groups of spinels and inverse spinels can advantageously be used as a high temperature electrode material in combination with a suitable binder which is for example a glass or a ceramic in an organic polymer binder, to form a solid-state electrochemical element.

In a first embodiment of the present invention the solid-state electrochemical element comprises an electrode comprising, as a host material for alkali metal ions, a normal spinel type material of the general formula A_{q}M₁₊ₓMn₁₋ₓO₄, in which general formula M represents a metal which is selected from the metals of the Periodic Table of the Elements having an atomic number from 22 (titanium) to 30 (zinc), other than manganese, or M represents an alkaline earth metal, x can have any value from −1 to 1, on the understanding that if the spinel comprises an alkaline earth metal or zinc, the atomic ratio of the total of alkaline earth metal and zinc to the total of other metals M and manganese is at most ⅓, and q is a running parameter which typically can have any value from 0 to 1, and which electrochemical element further comprises a solid inorganic binder.

The spinel type materials and also some of the further materials described hereinafter comprise an alkali metal. In such cases the alkali metal may be for example sodium or lithium. It is preferred that the alkali metal is lithium. Typically, all these materials comprise the same alkali metals and typically they comprise a single alkali metal. It is most preferred that all these materials comprise lithium as the single alkali metal. Thus, the electrochemically active alkali metal, i.e. the alkali metal A, is preferably solely lithium.

Preferably, for the normal spinel, the metal M is selected from chromium, iron, vanadium, titanium, copper, cobalt, magnesium and zinc. In particular, M represents chromium. The atomic ratio of the total of alkaline earth metal and zinc to the total of other metals M and manganese may be at least 1/10. The value of x may be for example −1, 0 or 1. Preferably x is in the range of from −0.9 to 0.9. In a more preferred embodiment x is in the range of from −0.5 to 0.5. In a most preferred embodiment x is in the range of from −0.2 to 0.2. Examples of the spinels for use in the invention are Li_{q}Cr₂O₄, Li_{q}CrMnO₄, Li_{q}Cr_{0.2}Mn_{1.8}O₄, Li_{q}Ti₂O₄, Li_{q}Mn₂O₄, Li_{q}FeMnO₄, Li_{q}Mg_{0.5}Mn_{1.5}O₄ and Li_{q}Zn_{0.1}Mn_{1.9}O₄.

In a second embodiment of the invention the electrochemical element comprises an electrode comprising, as a host material for alkali metal ions, a spinel type material comprising 16d octahedral sites for hosting alkali metal ions, which is known as an inverse spinel material.

The inverse spinel type material which is applied in the second embodiment of the electrochemical element according to this invention is typically selected such that at least 25% of the sites available for hosting alkali metal ions are 16d octahedral sites. Preferably at least 50%, more preferably at least 90%, most preferably at least 95% of the sites available for hosting alkali metal ions are 16d octahedral sites. In particular, all sites available for hosting alkali metal ions are 16d octahedral sites. This does not exclude that in the inverse spinel type materials another element, in addition to the alkali metal, occupies a portion of the 16d octahedral sites. For the sake of brevity, spinel type materials which comprise 16d octahedral sites for hosting alkali metal ions are designated hereinafter by the term “inverse spinel type material”.

A suitable inverse spinel type material is of the general formula A_{q}Ni_{1-a-b}COₐCu_{b}VO₄, wherein A represents an alkali metal, a and b can have any value from 0 to 1, on the understanding that a +b is at most 1, and q is a running parameter which typically can have any value from 0 to 1. Such inverse spinel type materials are known from U.S. Pat. No. 5,518,842, U.S. Pat. No. 5,698,338, G T K Fey et al., Journal of Power Sources, 68 (1997), pp. 159-165.

The inverse spinel type materials and also some of the further materials described hereinafter comprise an alkali metal. In such cases the alkali metal may be for example sodium or lithium. It is preferred that the alkali metal is lithium. Typically, all these materials comprise the same alkali metals and typically they comprise a single alkali metal. It is most preferred that all these materials comprise lithium as the single alkali metal. Thus, the electrochemically active alkali metal, i.e. the alkali metal A, is preferably solely lithium.

Preferred inverse spinel type materials are for example Li_{q}NiVO₄, Li_{q}Ni_{0.5}Co_{0.5}VO₄, Li_{q}CoVO₄, and Li_{q}CuVO₄ in which general formulae q has the meaning as given hereinbefore.

The alkali metal ions derived from the alkali metal A are extractable from the spinel or inverse spinel type material and, as a consequence, the value of the running parameter q changes in accordance with the state of charge/discharge of the electrochemical element. For the manufacture of the electrochemical element the spinel itself (q equals 1) is preferably used.

In general, spinel type materials may be made by admixing, for example, oxides, carbonates, nitrates or acetates of the metals, heating the mixture to a high temperature, for example in the range of 350-900° C., and cooling. For example, LiCr_{0.2}Mn_{1.8}O₄ can be made by heating a mixture of lithium nitrate, chromium trioxide and manganese dioxide at 600° C. and cooling the mixture (cf. G Pistola et al., Solid State Ionics 73 (1992), p. 285).

The skilled person will appreciate that the electrochemical element comprises, as electrodes, a cathode and an anode, and that it further comprises an electrolyte. The anode comprises a host material which has a lower electrochemical potential relative to the alkali metal than the host material of the cathode. The difference in the electrochemical potentials relative to the alkali metal, measured at 25° C., is typically at least 0.1 V and it is typically at most 10V. Preferably this difference is in the range of from 0.2 to 8 V.

The electrochemical element is a solid-state element, i.e. an electrochemical element which employs solid electrodes and a solid electrolyte, and no liquids are present. The use of a solid inorganic binder obviates the presence of liquid. The presence of liquid in the electrochemical elements is conventional, but disadvantageous in view of leakage during use and other forms of instability of the electrochemical element, especially at high temperature.

The cathode, the electrolyte and the anode, independently, may comprise a homogeneous material, or they may comprise a heterogeneous material. The heterogeneous material comprises frequently a particulate material embedded in the binder. It is preferred that the host materials of the cathode and/or the anode are present as particulate materials embedded in the binder. The binder may also present as a layer between the electrodes, binding the electrodes together.

U.S. Pat. No. 5,518,842, U.S. Pat. No. 5,698,338, WO-97/10620 and EP-A-470492 and the references cited in these documents disclose suitable materials, in addition to the spinel type material, for use in the electrodes and the electrolyte, and relevant methods for making electrochemical elements. Also reference may be made, for materials and for methods, to D Linden (Ed.), “Handbook of batteries”, 2^{nd} Edition, McGraw-Hill, Inc., 1995.

In order to have more practical value, it is desirable that the materials for making the electrodes and the electrolyte are selected such that in combination they sustain to a sufficient degree the temperature at which the electrochemical element is used and the applicable charging voltage, thus preventing the electrochemical element from degradation and capacity fading during cycling.

The electrochemical element comprises, as the binder, a solid inorganic material, for example a ceramic or, preferably, a glass. The glass is suitably a silicon, an aluminium or a phosphorus based glass, and it is suitably an oxide or an sulphide based glass. Mixed forms of two or more of such glasses are also possible.

By the addition of a suitable conductive filler, a non-conductive binder may be made conductive for alkali metal ions, or the non-conductive binder may be made conductive for electrons. Alternatively, a binder may be chosen which in itself is conductive. The binder may or may not comprise an inert filler, such as alumina, silica or boron phosphate. A binder which is conductive for alkali metal ions may be used as a constituent of a cathode, an electrolyte or an anode, and a binder which is conductive for electrons may be used as a constituent of a cathode or an anode. The electrolyte may suitable be made of the material of a binder itself, without a particulate material embedded therein, provided that the binder is conductive for alkali metal ions.

The binder is suitably a non-conductive binder or a binder which is conductive for alkali metal ions.

A non-conductive glass is for example a borosilicate glass or a boron phosphorus silicate glass.

The glass which is conductive for the alkali metal ions may suitably be selected from glasses which are obtainable by combining an alkali metal oxide, boron oxide and phosphorus pentoxide. Particularly useful are glasses of this kind which are of the general formula A₃ₓB₁₋ₓPO₄, in which general formula A represents an alkali metal and x may have any value from ⅛to ⅔, in particular ⅗. These glasses may be obtained by heating a mixture of the ingredients above 150° C., preferably 400-600° C.

Alternatively, the glass which is conductive for alkali metal ions may suitable be selected from glasses which are similarly obtainable by combining an alkali metal sulphide, an alkali metal halogen and boron sulphide and/or phosphorus sulphide, such as disclosed in J. L. Souquet, “Solid State Electrochemistry”, P. G. Bruce (Ed.), Cambridge University Press, 1995, pp. 74, 75. Preferably, the glass is obtainable by combining an alkali metal sulphide and phosphorus sulphide. Most preferably, the glass is of the formula P₂S₅.2Li₂S.

Other suitable glasses which are conductive for the alkali metal ions are of the general formulae A₄SiO₄ and A₃PO₄, in which general formulae A represents an alkali metal.

For increasing the conductivity for alkali metal ions the binder may comprise a particulate material which is conductive for the alkali metal ions. Such a particulate material may suitably be selected from

alkali metal salts, such as halogenides, perchlorates, sulphates, phosphates and tetrafluoroborates,

alkali metal aluminium titanium phosphates, for example Li_{1.3}Al_{0.3}Ti_{1.7}(PO₄)₃, and

any of the glasses which are conductive for alkali metal ions as described hereinbefore.

For increasing the conductivity for electrons, the binder may comprise a particulate material which is conductive for electrons. Such a particulate material may suitably be selected from carbon particles and metal particles, for example particles of copper or aluminium. Copper particles may preferably be used in the anode, and aluminium particles may preferably be used in the cathode.

In a preferred embodiment of the invention the electrical conductivity of the electrochemical element is increased by the presence in one or both electrodes and/or in the electrolyte of a small quantity of a low molecular weight polar organic compound. The quantity is preferably so small that the organic compound does not form a separate liquid phase and that the electrochemical element is a solid-state electrochemical element.

Low molecular weight polar organic compound have suitably up to 8 carbon atoms. Examples of such compounds are carbonates, amides, esters, ethers, alcohols, sulphoxides and sulphones, such as ethylene carbonate, dimethyl carbonate, N,N-dimethylformamide, gamma-butyrolactone, tetraethyleneglycol, triethyeleneglycol dimethyl ether, dimethylsulphoxide, sulpholane and dioxolane.

Now turning in more detail to the host materials of the electrodes, preferably the electrochemical element comprises a cathode comprising, as a host material for alkali metal ions, a spinel type material of the general formula A_{q}M₁₊ₓMn₁₋ₓO₄, with A, M, q and x being as defined hereinbefore, and it further comprises an anode comprising a host material for the said alkali metal ions. The skilled person will appreciate that in particular a host material of the anode will be selected which is also suitable for use at a high temperature.

Suitable host materials of the anode may be selected from

either inverse spinel type materials comprising 16d octahedral sites for hosting alkali metal ions or spinel type materials of the general formula A_{q}M₁₊ₓMn₁₋ₓO₄, with A, M, q and x being independently as defined hereinbefore,

alkali metal and titanium based spinel type materials, for example of the general formula A_{1+d+q}Ti_{2-d}O₄, wherein A denotes an alkali metal, d may have any value from 0 to ⅓, preferably d is ⅓, and q is a running parameter which typically can have any value from 0 to 5/3, preferably from 0 to 1,

alkali metals or alloys comprising an alkali metal,

carbons,

semiconductors selected from, for example, cadmium sulphide and silicon,

metal based glasses wherein the metal may be selected from tin, zinc, cadmium, lead, bismuth and antimony, and

titanium dioxides.

Thus, both electrodes may comprise a spinel type material of the general formula A_{q}M₁₊ₓMn₁₋ₓO₄, with A, M, q and x being independently as defined hereinbefore, as long as the host material of the cathode is of a higher electrochemical potential relative to the alkali metal than the host material of the anode.

As regards the metal based glasses, a suitable glass may be obtainable by combining a metal oxide, boron oxide and phosphorus pentoxide (cf. R A Huggins, Journal of Power Sources, 81-82 (1999) pp. 13-19). The metal oxide may be an oxide of tin, zinc, cadmium, lead, bismuth or antimony, preferably tin monoxide or lead monoxide, more preferably tin monoxide. Although not wishing to be bound by theory, it is thought that the metal oxide present in the glass so obtainable is reduced in-situ with formation of the corresponding metal, which can function as a host material for the alkali metal. The molar ratio of the metal oxide to boron oxide is typically in the range of from 4:1 to 1:1, preferably 2.5:1 to 1.5:1 and the molar ratio of the metal oxide to phosphorus pentoxide is in the range of from 4:1 to 1:1, preferably 2.5:1 to 1.5:1. The metal based glass may or may not be based, as an additional component, on an alkali metal oxide.

Carbon powders which are suitable for use in the anode may be, for example, natural graphites or materials which are obtainable by pyrolysis of organic materials, such as wood or fractions obtained in oil refinery processes.

Preferably the semiconductor is a nano-powder, typically having a particle size in the range of 1-100 nm.

The cathode and the anode may comprise independently

typically at least 30% w and typically up to 99.5% w, preferably from 40 to 70% w of the host material;

typically at least 0.1% w and typically up to 20% w, preferably from 2 to 15% w of the particulate material which increases the conductivity for electrons;

typically at least 0.2% w and typically up to 50% w, preferably from 5 to 40% w of the particulate material which increases the conductivity for alkali metal ions; and

typically at least 0.1% w and typically up to 20% w, preferably from 2 to 15% w of binder in which particulate materials may be embedded.

If no particulate material which increases the conductivity for alkali metal ions is present, the binder may be present in a quantity typically of at least 0.1% w and typically up to 70% w, preferably from 2 to 55% w. The quantities defined in this paragraph are relative to the total weight of each of the electrodes.

The electrolyte may comprise

typically at least 70% w and typically up to 99.5% w, preferably from 75 to 99% w of the particulate material which increases the conductivity for alkali metal ions; and

typically at least 0.1% w and typically up to 30% w, preferably from 1 to 25% w of binder in which a particulate material may be embedded.

The quantities defined in this paragraph are relative to the total weight of the electrolyte.

A preferred cathode comprises, based on the total weight of the cathode, 50% w of particles of a spinel type material of the formula Li_{q}Mn₂O₄ or Li_{q}CrMnO₄, with q being a running parameter which typically can have any value from 0 to 1, and 10% w of graphite powder, imbedded in 40% w of a binder which is a glass of the general formula Li₃ₓB₁₋ₓPO₄ wherein x is 0.6.

A preferred anode comprises, based on the total weight of the anode, 50% w of particles of a spinel type material of the general formula Li_{(4/3)+q}Ti_{5/3}O₄, in which general formula q is a running parameter which typically can have any value from 0 to 1, and 10% w of graphite powder, imbedded in 40% w of a binder which is a glass of the general formula Li₃ₓB₁₋ₓPO₄ wherein x is 0.6.

A preferred electrolyte comprises, based on the total weight of the electrolyte, 80% w of Li₄SiO₄ particles imbedded in 20% w of a binder which is a glass of the general formula Li₃ₓB₁₋ₓPO₄ wherein x is 0.6.

The electrochemical element comprises preferably a preferred cathode, a preferred anode and a preferred electrolyte as defined in the previous three paragraphs.

The electrodes and the electrolyte may be present in the electrochemical element in any suitable form. Preferably they are in the form of a layer, i.e. one dimension being considerably smaller than the other dimensions, e.g. in the form of a foil or a disk. Such layers can be made by mixing and extruding the ingredients with application of an extrusion technique. The skilled person is aware of suitable extrusion techniques.

The thickness of the layers may be chosen between wide limits. For example, the thickness of the electrode layers may be less than 2 mm and it may be at least 0.001 mm. Preferably the thickness of the electrode layers is the range of from 0.01 to 1 mm. The thickness of the electrolyte layer may be less than 0.02 mm and it may be at least 0.0001 mm. Preferably the thickness of the electrolyte layers is the range of from 0.001 to 0.01 mm. An advantage of using a glass as a binder is that it allows that thin layers can be made, yet of considerable strength.

The layers may be stacked in the order of cathode/electrolyte/anode to form a pack. Preferably each pack includes, as current collectors, a first metal layer adjacent to the cathode and a second metal layer adjacent to the anode, forming a pack of five layers, as follows: first metal/cathode/electrolyte/anode/second metal. A plurality of such five layer packs may be arranged in parallel or in series. The five layer packs may be stacked. The number of such five layer packs in a stack may be chosen between wide limits, for example up to 10 or 15, or even more. Alternatively, the five layer pack may be wound with an electrically insulating layer separating the metal layers, to form a cylindrical body.

The metal layers and the electrically insulating layers are preferably in the form of a foil or a disk, in accordance with the form of the anode, the electrolyte and the cathode. The thickness of these layers may be chosen between wide limits. For example, the thickness may be less than 1 mm and at least 0.001 mm, preferably in the range of 0.01 to 0.1 mm.

The first metal layer and the second metal layer may be made of any metal or metal alloy which is suitable in view of the conditions of use of the electrochemical element in accordance with this invention. Examples of suitable metals are copper and aluminium. The first metal layer is preferably made of aluminium. The second metal layer is preferably made of copper.

The electrically insulating layer may be made of any insulating material which is suitable in view of the conditions of use of the electrochemical element in accordance with this invention. The electrically insulating layer is preferably made of a non-conductive glass, as described hereinbefore. Alternatively, the insulating layer may be made of a polyimide, for example a polyimide which can be obtained under the trademark KAPTON.

Preferably the electrochemical elements for use in this invention are made by dynamic compaction of one or more of the five layer packs, suitably stacked or wound as described hereinbefore. The technique of dynamic compaction is known from, inter alia, WO-97/10620 and the references cited therein. Dynamic compaction uses a pressure pulse which results in a pressure wave travelling through the object to be compacted. The pressure pulse may be generated by an explosion using explosives, by an explosion via a gas gun or by magnetic pulses. Dynamic compaction leads to improved interfacial contact between the layers and between particulate materials and their surrounding binder. Therefore, dynamic compaction yields electrochemical elements which have a relatively low internal electrical resistance.

As part of the production process it may be needed to extract alkali metal from one or more of the spinel type materials. This can be done during the first charging of the electrochemical element. This can also be done separately by electrochemical extraction or by extraction with acid, such as disclosed in U.S. Pat. No. 4,312,930. The further construction of the electrochemical elements of this invention is preferably such that they can withstand high temperatures, high pressures and mechanical shocks.

The skilled person is aware of methods which he can apply for charging and any conditioning, if needed, of the electrochemical element.

The electrochemical element in accordance with the invention can be subjected to a plurality of charge/discharge cycles at a high temperature, exhibiting a good performance as regards the capacities delivered and maintained during the various charge/discharge cycles. The electrochemical element is typically a rechargeable battery.

The electrochemical element may be used under a large variety of conditions. It is a special feature of this invention that the electrochemical element may be used at a high temperature, for example at 40° C. or above. The electrochemical element is preferably used at a temperature of at least 55° C. In most instances the electrochemical element may be used at a temperature of at most 300° C. The electrochemical element is in particular used at a temperature between 65° C. and 250° C.

The electrochemical element is especially suitable for use inside processing equipment of chemical and oil processing plants, and in down hole locations in the exploration and production of gas and oil.

### EXAMPLE

A coin-cell rechargeable battery was made and tested at 110° C. in the following manner.

The anode material Li_{4/3}Ti_{5/3}O₄ (Hohsen Corp.) and the cathode material LiMn₂O₄ (Honeywell) were used as active electrode materials. The anode and cathode electrodes were fabricated via doctor-blade coating on 10 μm thick aluminium current collectors using a mixture of (1) the anode or cathode active material, (2) ceramic electrolyte powder, which comprises less than 1% by weight of dissolved alkali-containing salt, such as LiPF₆, LiBF₄, LiClO₄ and triflates (Li_{1.3}Al_{0.3}Ti_{1.7}(PO₄)₃), (3) carbon-black (MMM SuperP), (4) graphite (Timcal SFG10) and (5) a binder PVDF (Solvay) dissolved in 1-methylpyrolidone (NMP) (Merck) in the mass ratio 50:30:3:10:7. The coatings were quickly dried under vacuum at 140° C. for 15 minutes followed by drying under vacuum at 80° C. overnight. The resulting coatings were pressure rolled using a hand roller to a porosity of 40-50%. Free-standing electrolyte layers, referred to as electrolyte foils, were made via tape casting by a mixture of ceramic electrolyte powder (Li_{1.3}Al_{0.3}Ti_{1.7}(PO₄)₃) and a binder PVDF (Solvay) dissolved in NMP (Merck) in the mass ratio 93:7.

Samples of ø14-16 mm were cut from the anode and cathode electrode coatings, and electrolyte foils. All measurements were done using a CR2320 type coin-cell (Hohsen Corp.). To prevent corrosion of the coin-cell can (cathode electrode side) the bottom of the can was covered with aluminium foil. The coin-cell was assembled in the following stacking order: can, ø21 mm×10 μm Al, cathode electrode, ø18 mm×20 μm electrolyte foil, polypropylene gasket, anode electrode, spacer plate (Al ø17 mm×0.5 mm), ø15 mm wave-spring and cap. The active mass in this electrochemical element was 5.7 mg Li_{4/3}Ti_{5/3}O₄ anode material and 4.9 mg LiMn₂O₄ cathode material. Molten polar liquid ethylene carbonate (EC) was added in a significantly low quantity in order to create the film of the polar liquid to cover the particles. The coin-cells were sealed in a Helium filled glovebox (H₂O<5 ppm). During the measurements, the coin-cell was kept under pressure with a Hoffman clamp. The measurements were done with a Maccor S4000 battery tester using separate leads for current and voltage. The cell was thermostated at 110° C. in a climate chamber. The measurements comprised charging and discharging at a constant current of 0.385 mA between 2.0 and 2.7 V during five charge and discharge cycles of 3.2 hours. The combination of the anode and cathode materials into this electrochemical element resulted in a battery with a voltage between 2.2 and 2.5 V. The measured charge and discharge capacities of the electrochemical element were between 0.52 and 0.60 mAh.

1. A solid-state electrochemical element comprising a layer of electrolyte which is sandwiched between cathode and anode electrodes, which electrodes comprise an alkali metal ion and host material of a spinel type structure containing active component and an electronically conductive component, which components are at least partly covered by a liquid film coating and are embedded in a matrix binder material, wherein the electrolyte layer comprises ceramic electrolyte particles that are essentially free of electronically conductive components and comprise less than 1% by weight of dissolved alkali containing salt, which particles are at least partly covered by a liquid film coating and are embedded in a matrix binder material.

2. The electrochemical element of claim 1, wherein the ceramic electrolyte particles comprise less than 0.5% by weight of dissolved alkali containing salt, such as LiPF₆, LiBF₄, LiCLO₄ or triflates, are essentially free of C, Al, Cu or other electrically conductive components and are at least partly covered by a film of a polar liquid.

3. The electrochemical element of claim 1, wherein at least one of the electrodes comprises an alkali metal ion containing active component which comprises as a host material for alkali metal ions, a spinel type material of the general formula A_{q}M₁₊ₓMn₁₋ₓO₄, in which general formula M represents a metal which is selected from the metals of the Periodic Table of the Elements having an atomic number from 22 (titanium) to 30 (zinc), other than manganese, or M represents an alkaline earth metal, x can have any value from −1 to 1, on the understanding that if the spinel comprises an alkaline earth metal or zinc, the atomic ratio of the total of alkaline earth metal and zinc to the total of other metals M and manganese is at most ⅓, and q is a running parameter, and which electrochemical element further comprises a solid inorganic binder.

4. An electrochemical element as claimed in claim 3, characterised in that x is in the range of from −0.9 to 0.9.

5. An electrochemical element as claimed in claim 3 or 4, characterised in that the running parameter q can have any value from 0 to 1.

6. An electrochemical element as claimed in claim 3 or 5, characterised in that M represents chromium.

7. An electrochemical element as claimed in any of claims 3-6, characterised in that the binder is a glass.

8. An electrochemical element as claimed in claim 7, characterised in that the glass is a glass which is conductive for alkali metal ions which is selected from
glasses of the general formula A₃ₓB₁₋ₓPO₄, in which general formula A represents an alkali metal and x may have any value from ⅛ to ⅔;
glasses which are obtainable by combining an alkali metal sulphide, an alkali metal halogen and boron sulphide and/or phosphorus sulphide; and
glasses of the general formulae A₄SiO₄ and A₃PO₄, in which general formulae A represents an alkali metal.

9. An electrochemical element as claimed in any of claims 3-8, characterised in that it comprises a particulate material which is conductive for the alkali metal ions and which is embedded in the binder, wherein the particulate material which is conductive for the alkali metal ions is selected from
alkali metal salts, such as halogenides, perchlorates, sulphates, phosphates and tetrafluoroborates,
alkali metal aluminium titanium phosphates, and
any of the glasses which are conductive for alkali metal ions as defined in claim 10.

10. An electrochemical element as claimed in any of claims 3-8, characterised in that it comprises a cathode comprising, as a host material for alkali metal ions, the spinel type material of the general formula A_{q}M₁₊ₓMn₁₋ₓO₄, with A, M, q and x being as defined in any of claims 1-4, and it further comprises an anode comprising a host material for the said alkali metal ions, which host material is selected from
spinel type materials of the general formula A_{q}M₁₊ₓMn₁₋ₓO₄, with A, M, q and x being independently as defined in any of claims 1-4,
alkali metal and titanium based spinel type materials, for example of the general formula A_{1+d+q}Ti_{2-d}O₄, wherein A denotes an alkali metal, d may have any value from 0 to ⅓, preferably d is ⅓, and q is a running parameter,
alkali metals or alloys comprising an alkali metal,
carbons,
semiconductors selected from, for example, cadmium sulphide and silicon,
metal based glasses wherein the metal may be selected from tin, zinc, cadmium, lead, bismuth and antimony, and
titanium dioxides.

11. An electrochemical element as claimed in any of claims 3-10, characterised in that the electrochemically active alkali metal, i.e. the alkali metal A, is preferably solely lithium.

12. The electrochemical element of claim 1, wherein at least one of the electrodes comprises, as a host material for alkali metal ions, a spinel type material comprising 16d octahedral sites for hosting alkali metal ions.

13. An electrochemical element as claimed in claim 12, characterised in that it comprises a glass as a binder.

14. An electrochemical element as claimed in claim 13, characterised in that the glass is a glass which is conductive for alkali metal ions which is selected from
glasses of the general formula A₃ₓB₁₋ₓPO₄, in which general formula A represents an alkali metal and x may have any value from ⅛ to ⅔;
glasses which are obtainable by combining an alkali metal sulphide, an alkali metal halogen and boron sulphide and/or phosphorus sulphide; and
glasses of the general formulae A₄SiO₄ and A₃PO₄, in which general formulae A represents an alkali metal.

15. An electrochemical element as claimed in claim 12, characterised in that it comprises a particulate material which is conductive for the alkali metal ions and which is embedded in a binder, wherein the particulate material which is conductive for the alkali metal ions is selected from
alkali metal salts, such as halogenides, perchlorates, sulphates, phosphates and tetrafluoroborates,
alkali metal aluminium titanium phosphates, and
any of the glasses which are conductive for alkali metal ions as defined in claim 9.

16. A process for preparing an electrochemical element as defined in any of claims 1-15, wherein one or more five layer packs are subjected to dynamic compaction, wherein the five layer packs comprise consecutive layers of a first metal, the cathodic electrode, the electrolyte layer, the anodic electrode and a second metal.

17. Use of an electrochemical element as claimed in any of claims 1-15 at a temperature of at least 40° C.

18. The use as claimed in claim 17, characterised in that the electrochemical element is used at a temperature between 55° C. and 250° C.
